(19) United States
(12) Patent Application Publication
(10) Pub. No.: US 2024/0403437 A1
(43) Pub. Date: Dec. 5, 2024

(54) EXTERNAL API VULNERABILITY ASSESSMENTS

(71) Applicant: Cisco Technology, Inc., San Jose, CA (US)

(72) Inventors: Thomas Szigeti, Vancouver (CA); Shannon K. MCFARLAND, Parker, CO (US); Walter Theodore HULICK, JR., Pearland, TX (US); David John ZACKS, Vancouver (CA)

(21) Appl. No.: 18/205,331

(22) Filed: Jun. 2, 2023

(51) Int. Cl. G06F 21/57

(52) U.S. Cl. CPC G06F 21/577; G06F 2221/034

(57) ABSTRACT

In one embodiment, external API vulnerability assessments may include detecting, by a process, usage of an external application programming interface in execution of an application; transmitting, by the process, a query to the external application programming interface for a list of one or more components of the external application programming interface; generating, by the process, a vulnerability assessment for the application based on a response to the query; and performing, by the process, one or more mitigation actions based on the vulnerability assessment.

### TECHNICAL FIELD

The present disclosure relates generally to computer systems, and, more particularly, to external API vulnerability assessments.

### BACKGROUND

s Organizations are increasingly adopting Cloud Native architectures, as these enable rapid application development with flexibility, stability, portability, and scale. However, microservice-based architectures also massively increase the attack surface and expose applications to new vulnerabilities and threats, thus requiring a whole new approach to application security.

Of particular concern, application programming interface (API) breaches are on the rise as attack vectors for software applications. Since API services can provide access to data being managed by an enterprise application, API attacks put this data at risk. There are frequent reminders of this risk in the form of regular high-profile API-based data breaches. Meanwhile, a persistent theme among security professionals is that developers are producing APIs too quickly and without regard to best practices, leaving them hopelessly behind in API vulnerability identification and mitigation.

While some tools exist for internal API analysis, all available solutions ignore that, in a cloud native environment, an organization's threat surface is not limited to their internal applications. Rather, modern microservices also face threats from all third-party API endpoints to which they connect. As a result, today's microservice hosting organizations lack visibility into the software bill of materials (SBOMs) of external API endpoints upon which they rely. As such, these organizations do not have an accurate way to assess the risk exposure of their internal workloads to software vulnerabilities from the external API endpoints, nor do they possess any means to enforce any kind of insight-based mitigation policies that such visibility could enable.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of a computer network;

FIG. 2 illustrates an example of a computing device/node;

FIG. 3 illustrates an example of an observability intelligence platform;

FIG. 4 illustrates an example of an application security platform architecture for external API vulnerability assessments; and

FIG. 5 illustrates an example simplified procedure for external API vulnerability assessments in accordance with one or more embodiments described herein.

### DESCRIPTION OF EXAMPLE EMBODIMENTS

### Overview

According to one or more embodiments of the disclosure, performing external API vulnerability assessments may include detecting, by a process, usage of an external application programming interface in execution of an application; transmitting, by the process, a query to the external application programming interface for a list of one or more components of the external application programming interface; generating, by the process, a vulnerability assessment for the application based on a response to the query; and performing, by the process, one or more mitigation actions based on the vulnerability assessment.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

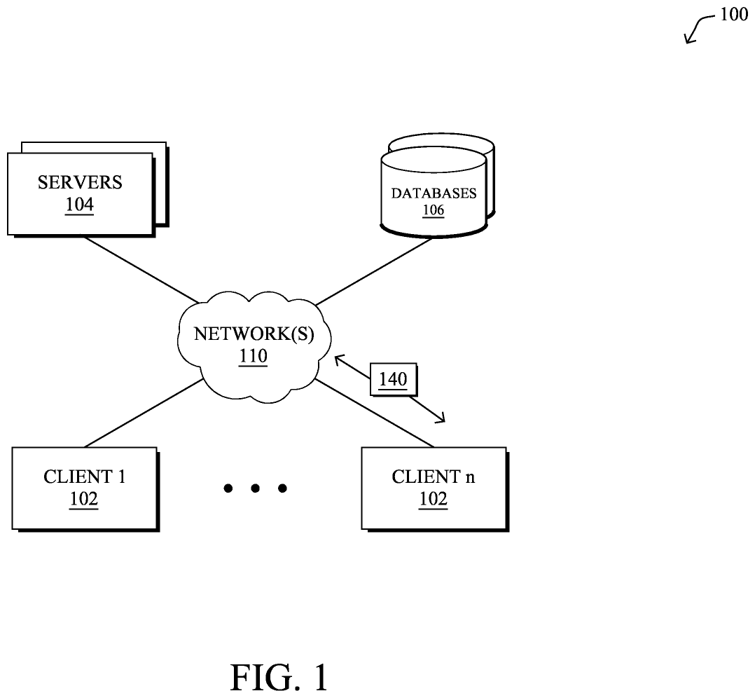

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

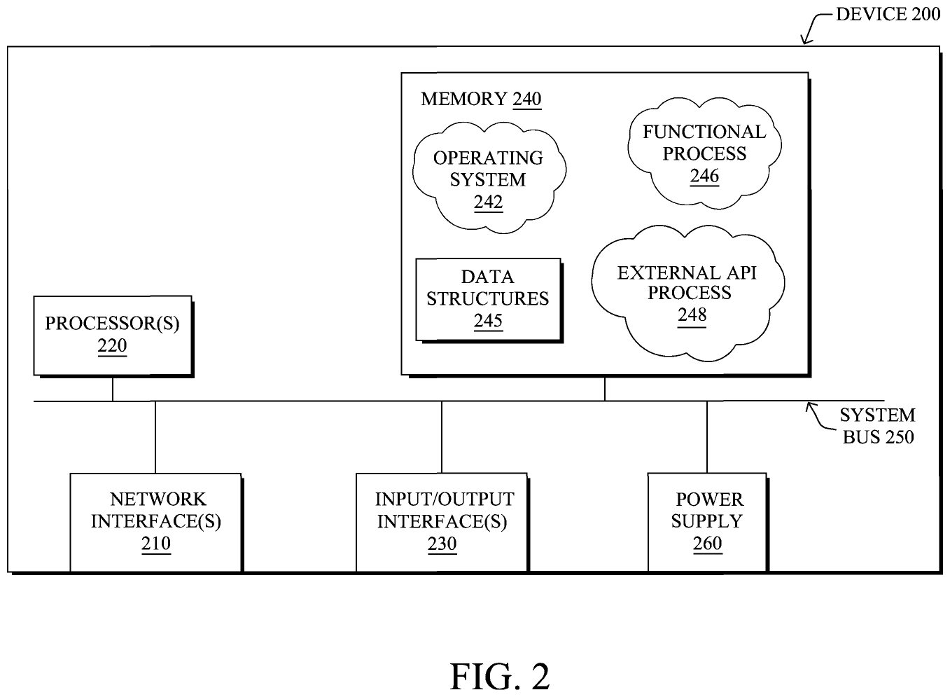

FIG. 2 is a schematic block diagram of an example node/device 200 that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 may contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise one or more functional processes 246, and on certain devices, an illustrative “external API assessment” process 248, as described herein. Notably, functional processes 246, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### Observability Intelligence Platform

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicates the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

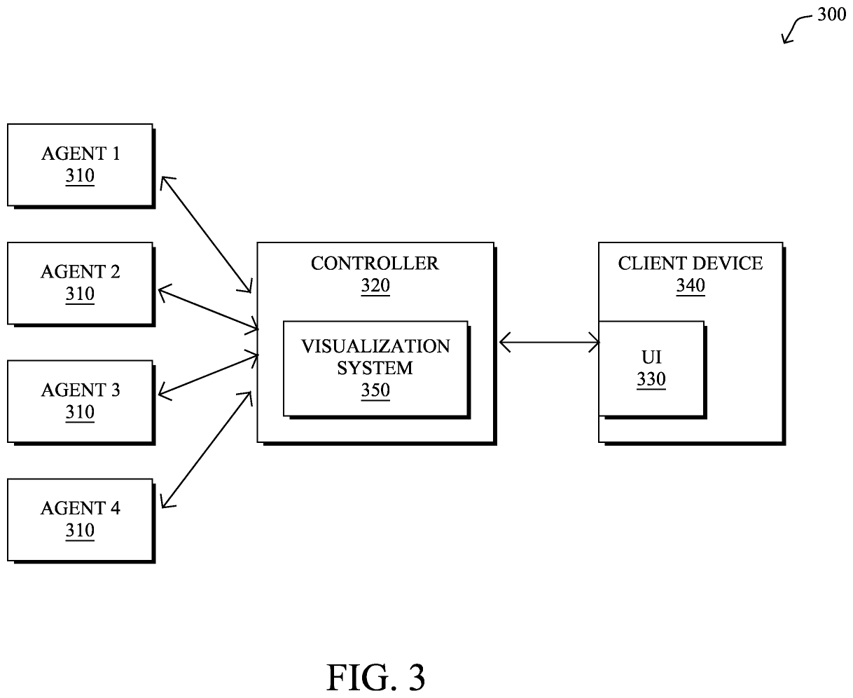

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) 330 that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller 320 instance may be hosted remotely by a provider of the observability intelligence platform 300. In an illustrative on-premises (On-Prem) implementation, a controller 320 instance may be installed locally and self-administered.

The controllers 320 receive data from different agents 310 (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### External API Vulnerability Assessments

As noted above, API attacks and vulnerabilities are a top-of-mind security concern for cloud native application managers. For example, some estimates predict that API attacks will become the most frequent attack vectors exploited in future data breaches of enterprise web applications. In line with these predictions, API exploits have been observed to be increasing at a rate of hundreds of percent quarter-over-quarter.

Increasingly, it is important to recognize that in a cloud native environment an organization's threat surface is not limited to their internal applications, but rather includes any and all third-party API endpoints to which they are connecting. However, organizations currently lack visibility into the software bill of materials (SBOMs) of such external API endpoints, and as such, do not have an accurate way to assess their exposure to software vulnerabilities from these, nor any means to enforce any kind of policy that such insights could enable.

In contrast, the techniques herein introduce a mechanism to provide this visibility into the components of the external API endpoints and/or any security vulnerabilities that they represent. In various embodiments, this includes a mechanism to publish, query, and/or analyze SBOMs for external API endpoints to assess their software risks and to automate the detection and reporting of these software risks to security operators and developers, as well as to trigger policy actions throughout an application's lifecycle.

Illustratively, the techniques described herein may be performed by hardware, software, and/or firmware, such as in accordance with external API assessment process 248, which may include computer executable instructions executed by the processor 220 (or independent processor of interfaces 210) to perform functions relating to the techniques described herein.

Specifically, according to one or more embodiments described herein, performing external API vulnerability assessments may include detecting, by a process, usage of an external application programming interface in execution of an application; transmitting, by the process, a query to the external application programming interface for a list of one or more components of the external application programming interface; generating, by the process, a vulnerability assessment for the application based on a response to the query; and performing, by the process, one or more mitigation actions based on the vulnerability assessment.

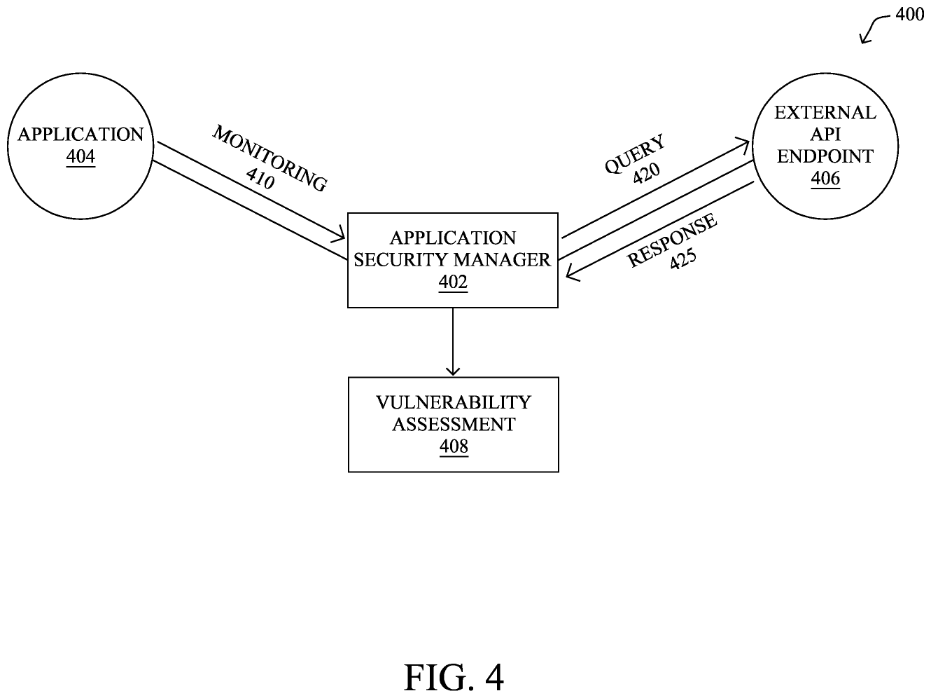

Operationally, FIG. 4 illustrates an example of an application security platform architecture 400 for external API vulnerability assessments, in accordance with one or more embodiments described herein. Application security platform architecture 400 may utilize SBOM insights to generate a vulnerability assessment 408 of external API endpoints.

An SBOM details the list of software ingredients within an application/application microservice, including (but not limited to) the underlying software components of an application, libraries in use, dependencies in use, open-source code in use, which git repos were used, etc. This in turn can be used to determine if any of the underlying software components pose a risk to the application or to its users.

SBOMs are receiving increasing recognition, such as in a recent US Executive Order on Cybersecurity mandating the providing of a public SBOM for every software product produced in order to secure the software supply chain. However, as previously outlined, there is presently no visibility into the SBOMs of external API endpoints.

Application security platform architecture 400, however, may be utilized to provide SBOM visibility into the external API endpoints. In addition, application security platform architecture 400 may analyze the external API endpoint SBOM information and assess it for risk. In turn, this information may be reported to the SecOps/DevSecOps teams to provide them with a more accurate and comprehensive report of the overall threat exposure of an organization, inclusive of external third-party APIs. Moreover, the application security platform architecture 400 may be leveraged to shift API security left by incorporation of continuous integration/continuous delivery (CI/CD) plugins to automate the identification and correlation of applications that may (at some point in the future) attempt to connect to API endpoints that have risky SBOMs.

Application security platform architecture 400 may utilize an application security manager 402 to accomplish these functions. In fact, application security manager 402 may facilitate SBOM visibility and risk assessment throughout the entire software development lifecycle, from development to runtime.

Application security manager 402 may be deployed at a server, controller, etc. having access to development, deployment, runtime, etc. environments of an application 404. For example, application security manager 402 may be implemented as a component of a controller such as an admission controller. For instance, application security manager 402 may be a component of an admission controller that can enforce deployment requirements and restrictions in a cluster (e.g., upon every workload start and/or any configuration change). The application security manager 402 may be deployed to the same cluster where applications, such as application 404, are being developed, deployed, run, etc.

In various embodiments, application security manager 402 may monitor activity, data, traffic, information, etc. associated with application 404 (e.g., monitoring 410). Monitoring 410 may include monitoring these aspects during development, deployment, runtime, etc. Application 404 may include an application, application microservice, and/or any type of workload. Application 404 may be an internal (e.g., developed, managed, deployed, operated, hosted, etc. by a same organization associated with operation of the application security manager 402) containerized workload.

Application 404 may be deployed in a virtual environment such as a cluster. For example, application 404 may be deployed as images, containers, Kubernetes, runtime deployments, etc. Application 404 may be within any stage of the CI/CD lifecycle including development environment, deployment environment, and/or runtime environment when monitored and/or assessed by application security manager 402. In some instances, the application security manager 402 may be deployed as a component of an admission controller controlling admission for and/or running on the same virtual environment as application 404, thereby facilitating an agent-less solution to identify and protect from vulnerabilities across images, containers, Kubernetes, and runtime environments.

Application 404 may be configured to make one or more API calls, when executing, to external API endpoint 406. The external API endpoint 406 may be an endpoint outside of an organization's network and/or one that is hosted by a third-party service provider relative to application 404 and/or application security manager 402. Calls from application 404 to external API endpoint 406 may be used to enable communication and/or data exchange between application 404 within an organization's network and the external API endpoint 406 outside of the organization's network. Since the external API endpoint 406 is outside the control, supervision, and/or network of the organization developing, deploying, and/or supporting application 404 (e.g., it is hosted by a third-party), that organization may not have an inherent ability to access information about external API endpoint outside of that facilitated through application security manager 402.

There are tools available to generate SBOM information for a given containerized service and/or external API endpoint 406. However, the organization offering the application 404 does not necessarily have access to the SBOM information of the external API endpoint 406 (e.g., held by third parties), even though the application 404 may rely on interactions with the external API endpoint 406 to perform its functions. Application security manager 402 component of application security platform architecture 400 may facilitate the exchange of this information in various circumstances described below.

At the core of this information sharing ability is a SBOM information query, collection, and analysis functionality of application security manager 402. Application security manager 402 may facilitate the sharing of SBOM information for the external API endpoint 406 via communication with the external API endpoint 406 itself (e.g., query 420, response 425). For instance, exchange of SBOM information from a third-party external API endpoint may be facilitated by incorporating additional parameters to the API that can be queried.

In various embodiments, a full SBOM query parameter (e.g., SBOM_FULL) may be added to the API. A query 420 (e.g., by application security manager 402) of SBOM_FULL for the external API endpoint 406 may return a query response (e.g., response 425) from the external API endpoint 406. This query response may include the full SBOM for the external API endpoint 406.

Alternatively, or additionally, a component specific SBOM query parameter (e.g., SBOM_COMPONENT) may be added to the API which facilitates checking of the external API endpoint 406 for a specific software component incorporated therein. As such, application security manager 402 may submit a direct query for a specific component to SBOM_COMPONENT. For example, application security manager 402 may submit a query to SBOM_COMPONENT of ‘Are you running log 4j?’. The external API endpoint 406 may return a response to the query such as ‘TRUE’ or ‘FALSE,’ depending on whether log 4j is present anywhere with the external API endpoint 406 SBOM. This querying structure can provide, on-demand, a full and/or a limited granular access to the SBOM of an external API endpoint 406 by direct querying of the external API endpoint 406.

In various embodiments, application security manager 402 may be a component of, and/or communicatively coupled to, a cloud-native application protection platform (CNAPP) capable of monitoring, detecting, and/or acting on potential cloud security threats and/or vulnerabilities present in an organization's applications. The CNAPP may be configured to monitor traffic associated with applications executing in runtime. For example, the CNAPP may utilize an Istio service mesh technology for layer 7 deep packet inspection of traffic associated with their applications in pre- and post-encryption. Therefore, the CNAPP may have full visibility into what APIs are currently in use in their runtime environment. In addition, the CNAPP may have access to and/or manage portions of the application development and/or deployment environments.

This API visibility may be used to detect a connection by an application 404 to an external API endpoint 406. For instance, connections to “new” external API endpoints may be detected. A connection to a “new” external API endpoint may include:
a connection to a previously unencountered external API endpoint from the perspective of the connecting application and/or with respect to the application security manager 402,
a connection to an external API endpoint that has not yet had its SBOM information queried by application security manager 402,
a connection to an external API endpoint whose SBOM information has not been queried by application security manager 402 for a threshold period of time,
a connection to an external API endpoint whose SBOM information has not been queried by application security manager 402 since a network event,
a connection to an external API endpoint whose SBOM information has not been queried by application security manager 402 since an update to an external API endpoint,
a connection to an external API endpoint whose SBOM information has not been queried by application security manager 402 since an identification of new known vulnerability and/or an update to vulnerability and/or bug fix definitions,
etc.

When a connection to one of these “new” external API endpoints is detected, then (in addition to observing the flow) application security manager 402 can issue an SBOM information query. The SBOM information query may be issued as an HTTP GET request for the external API endpoint 406. For example, the application security manager 402 may issue an HTTP GET request for SBOM_FULL to the external API endpoint 406. The external API endpoint 406 may, in turn, respond with the full SBOM of the external API endpoint 406.

Likewise, a new software vulnerability may be learned (e.g., entered by a security operator, published to and/or retrieved from a web resource, detected or discovered by the organization, etc.) and application security manager 402 may determine which external API endpoints associated with workloads under its management may be exposed to such a vulnerability. In such an example, application security manager 402 may search for all instances of the vulnerable software component of all external API endpoints via an SBOM information query. The SBOM information query may be a component specific query, such as a SBOM_COMPONENT query (e.g., querying a specific new vulnerability) to all known external API endpoints called by the applications under its management.

Regardless of the scope of the SBOM information query, there may be a reliance on third-party API endpoint providers to provide informative responses to the queries. Although not presently an industry norm, a third-party API endpoint provider may decide to make their SBOMs available via an API to drive trust and thus usage. As previously mentioned, US software vendors are mandated to provide SBOMs for every software product produced. Furthermore, most businesses consider SBOMs as part of their software procurement decisions. As such, third-party API SBOM transparency may drive adoption, especially when recognizing that APIs are the fastest growing security attack vector.

In either instance, application security manager 402 may analyze the SBOM information (e.g., the full SBOM from the SBOM_FULL query, the component specific SBOM information from the SBOM_COMPONENT query, etc.) that was returned from the external API endpoint 406. Application security manager 402 may utilize this analysis to generate a vulnerability assessment 408. The vulnerability assessment 408 may characterize external API endpoint SBOM risk exposure for currently running application microservices. For example, application security manager 402 may identify known Common Vulnerability Scoring System (CVSS) scores and bug reports and fixes for the components specified in the SBOM of the external API endpoint 406 and package these findings as a vulnerability assessment 408 of the external API endpoint 406. Each external API endpoint may receive its own vulnerability assessment 408.

The vulnerability assessment 408 for the external API endpoint 406 may be used to trigger automated policy actions. For example, the identification of a vulnerability in an external API endpoint 406 may be used to automatically trigger generation of an automated alert to a security manager, automated blocking of connections to the external API endpoint 406, automated steering of traffic to less risky external API endpoints, etc.

In addition, application security manager 402 may be utilized to identify SBOM risk exposure that may exist for an organization's applications (e.g., all applications) that are in their CI/CD pipeline. This may include applications that are not yet instantiated and/or may be instantiated sometime in the future. For example, a CI/CD environment plug-in may be incorporated in the CI/CD environment that automatically scans all application code in developments for external API endpoint calls. External API endpoint calls may share common components that can be utilized in identifying them within application instances. For instance, external API endpoint calls may share a common protocol and method (e.g., HTTP GET), as well as a Fully-Qualified Domain Name (FQDM) of the external API endpoint 406, the version, etc. As an example, an API call may be: GET https://developer.external.org/api/random-parameter/v1/. . . . Internal API calls may use the same DNS domain as the organization (e.g., “organization.com”); whereas any other domain used in the FQDN would indicate an external API endpoint.

The CI/CD plug-in may then use a telemetry data communication standard (e.g., Open Telemetry) communication to report the findings to the application security manager 402 running within a local cluster. The application security manager 402 may have already encountered the reported API calls in runtime (e.g., for other applications) and thus already have not only the SBOM information for these external API endpoints, but also a corresponding vulnerability assessment 408 including their security risk assessment.

Alternatively, the application security manager 402 may have not yet encountered an instantiation of the application microservice in the runtime. In such a case, an SBOM information query (e.g., SBOM_FULL, SBOM_COMPONENT, etc.) to the relevant external API endpoint may be automatically triggered as well as a resulting vulnerability assessment based on analysis of the response to such a query.

In either case, application security manager 402 may correlate risk analysis results (e.g., the vulnerability assessment 408) with the application microservice (e.g., application 404) that includes the external API endpoint call. This correlation of application microservices, external API endpoints, and their respective SBOM risks can thus be correlated and compiled for all applications in the CI/CD pipeline. Such reporting would not only be tremendously valuable to security operators (providing them with a more accurate assessment of their overall threat exposure than previously possible), but also to developers (as they would become aware of external API endpoint risks earlier in the CI/CD cycle and thus and would be able to more quickly and efficiently remediate risk exposure).

In addition, in both cases, the resulting vulnerability assessment 408 may be utilized to generate policy actions. Policy actions may include automated actions preventing certain images from spinning up or quarantining ones that do, etc. Therefore, the application security manager 402 may work in conjunction with the integrated CI/CD plug-in to facilitate automated and proactive identification and/or remediation of SBOM risks from external API calls within all application microservices still in the pipeline.

Therefore, application security manager 402 expands beyond the identification of SBOMs for code within an organization's internal CI/CD pipeline to incorporate obtaining and analyzing SBOM information from external third-party hosts, specifically third-party API-endpoints. Since such third-party endpoint hosts are being directly connected to the organization via these API communications, it is warranted for operators to ascertain their software composition, so as to prevent/mitigate vulnerabilities from being exploited from this lateral attack vector. For example, if a security operator was considering which API endpoint host to use for a given function, and he knew that one of the hosts was running log 4j, but another had been patched for it, then the operator can make an informed decision to select the API endpoint host that has been patched.

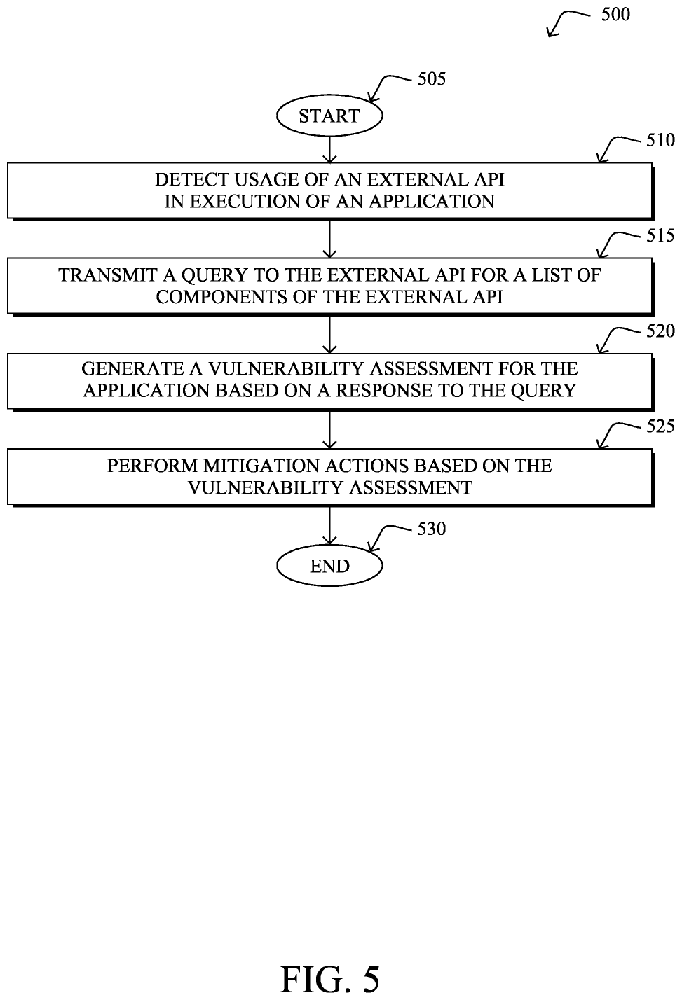

In closing, FIG. 5 illustrates an example simplified procedure for external API vulnerability assessments in accordance with one or more embodiments described herein. For example, a non-generic, specifically configured device (e.g., device 200) may perform procedure 500 by executing stored instructions (e.g., external API assessment process 248). Procedure 500 may be a process that is executed as part of a cloud-native application protection platform.

Procedure 500 may start at step 505, and continues to step 510, where, as described in greater detail above, procedure 500 may include detecting usage of an external application programming interface in execution of an application. The application may be an application; an application micro service; a workload; a containerized workload; an image; a container; a local application; and/or a virtual application.

Detecting usage of the external application programming interface in execution of the application may include monitoring activity of the application and determining a new call made to the external application programming interface during execution of app, wherein the query is transmitted in response to the new call to the external application programming interface. In various embodiments, detecting usage of the external application programming interface in execution of the application may be performed during development of the application, during deployment of the application, and/or during runtime of the application.

At step 515, procedure 500 may include transmitting a query to the external application programming interface for a list of one or more components of the external application programming interface. The query for the list of one or more components and the response to the query may be based on a software bill of materials for the external application programming interface. In various embodiments, the query to the external application programming interface for the list of one or more components of the external application programming interface may include a query for a full list of all components of the external application programming interface. Alternatively, or additionally, the query to the external application programming interface for the list of one or more components of the external application programming interface may include a query for presence of one or more specifically queried components of the external application programming interface.

As detailed above, at step 520 procedure 500 may include generating a vulnerability assessment for the application based on a response to the query. The vulnerability assessment may correspond to one or more of the external application programming interface in its entirety, one or more individual components of the external application programming interface, and/or a plurality of external application programming interfaces of the application. In various embodiments, the vulnerability assessment may be based on one or both of Common Vulnerability Scoring System scores and bug reports and fixes for specified components.

At step 525, as described in greater detail above, procedure 500 may include performing one or more mitigation actions based on the vulnerability assessment. Performing one or more mitigation actions based on the vulnerability assessment may include triggering a customized policy action based on the vulnerability assessment. The one or more mitigation actions may include sending an alert regarding the external application programming interface, sending a report regarding the external application programming interface, blocking certain components of the external application programming interface, blocking the external application programming interface, blocking the application, and/or redirecting calls to the external application programming interface.

The simplified procedure 500 may then end in step 535, notably with the ability to continue detecting additional external API usage, querying the additional external API for components, generating vulnerability assessments based on query responses, and/or performing mitigation based on the vulnerability assessments. Other steps may also be included generally within procedure 500. For example, such steps (or, more generally, such additions to steps already specifically illustrated above), may include: learning of a new vulnerability associated with a specific component, determining whether the application has any external application programming interfaces that have that specific component, and/or updating the vulnerability assessment based on whether the application has any external application programming interfaces that have that specific component; determining whether it is known that a given external application programming interface of the application has that specific component, and/or in response to determining that is unknown whether the given external application programming interface of the application has that specific component, querying the given external application programming interface of the application for presence of the specific component; and so on.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for external API vulnerability assessments. In particular, the techniques herein introduce SBOM information visibility into external API endpoints which may be hosted by third-party parties distinct from a party hosting a workload that calls to those API endpoints. Introducing this level of visibility provides powerful new insights into potential security risks posed by calls to these external API endpoints without the need to establish and maintain complex trust relationships and identity verifications systems. Instead, by leveraging SBOM information queries to and responses from external API endpoints, the visibility to provide vulnerability assessments is readily accessible. These capabilities also represent a shift-left of API security that, when integrated in the CI/CD lifecycle facilitates early and informed vulnerability assessments regarding external API usage throughout software development. In addition, these capabilities enable an array of automated mitigation measures to be deployed in response to risk assessments.

As a result, these techniques usher in an array of computing device operation and communication improvements. For example, security vulnerabilities can be rapidly and/or proactively identified before jeopardizing computing resources, network bandwidth, and data communications. In addition, the CI/CD lifecycle process, application security processes, and/or vulnerability and exploit mitigation processes can all be streamlined with this addition of automated measures to identify and mitigate vulnerabilities, thereby freeing up network resources to improve throughput and bandwidth consumption. Furthermore, the incorporation of these techniques with other functionalities, such as rating services for rating websites and API endpoints for threats and vulnerabilities, not only improves the operation of these systems while reducing their resource requirements, but also facilitates a new level of accuracy and granularity in their operation and output, thereby improving upon their contributions to computing device and communication network improvement.

Illustratively, the techniques described herein may be performed by hardware, software, and/or firmware, such as in accordance with the illustrative external API assessment process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the external API assessment process 248.

According to the embodiments herein, an illustrative method herein may comprise: detecting, by a process, usage of an external application programming interface in execution of an application; transmitting, by the process, a query to the external application programming interface for a list of one or more components of the external application programming interface; generating, by the process, a vulnerability assessment for the application based on a response to the query; and performing, by the process, one or more mitigation actions based on the vulnerability assessment.

In one embodiment, detecting usage of the external application programming interface in execution of the application comprises: monitoring activity of the application; and determining a new call made to the external application programming interface during execution of app, wherein the query is transmitted in response to the new call to the external application programming interface. In one embodiment, detecting usage of the external application programming interface in execution of the application is performed during development of the application, during deployment of the application, and/or during runtime of the application.

In one embodiment, the method further comprising: learning of a new vulnerability associated with a specific component; determining whether the application has any external application programming interfaces that have that specific component; and updating the vulnerability assessment based on whether the application has any external application programming interfaces that have that specific component. In one embodiment, the method further comprising: determining whether it is known that a given external application programming interface of the application has that specific component; and in response to determining that is unknown whether the given external application programming interface of the application has that specific component, querying the given external application programming interface of the application for presence of the specific component.

In one embodiment, the query for the list of one or more components and the response to the query are based on a software bill of materials for the external application programming interface. In one embodiment, the query to the external application programming interface for the list of one or more components of the external application programming interface comprises a query for a full list of all components of the external application programming interface. In one embodiment, the query to the external application programming interface for the list of one or more components of the external application programming interface comprises a query for presence of one or more specifically queried components of the external application programming interface.

In one embodiment, the application is selected from a group consisting of: an application; an application micro service; a workload; a containerized workload; an image; a container; a local application; and a virtual application. In one embodiment, the vulnerability assessment corresponds to one or more of the external application programming interface in its entirety, one or more individual components of the external application programming interface, or a plurality of external application programming interfaces of the application. In one embodiment, the vulnerability assessment is based on one or both of Common Vulnerability Scoring System scores and bug reports and fixes for specified components.

In one embodiment, the process is part of a cloud-native application protection platform. In one embodiment, performing the one or more mitigation actions based on the vulnerability assessment comprises: triggering a customized policy action based on the vulnerability assessment. In one embodiment, the one or more mitigation actions are selected from a group consisting of: sending an alert regarding the external application programming interface; sending a report regarding the external application programming interface; blocking certain components of the external application programming interface; blocking the external application programming interface; blocking the application; and redirecting calls to the external application programming interface.

According to the embodiments herein, an illustrative tangible, non-transitory, computer-readable medium herein may have computer-executable instructions stored thereon that, when executed by a processor on a computer, may cause the computer to perform a method comprising: detecting usage of an external application programming interface in execution of an application; transmitting a query to the external application programming interface for a list of one or more components of the external application programming interface; generating a vulnerability assessment for the application based on a response to the query; and performing one or more mitigation actions based on the vulnerability assessment.

Further, according to the embodiments herein an illustrative apparatus herein may comprise: one or more network interfaces to communicate with a network; a processor coupled to the network interfaces and configured to execute one or more processes; and a memory configured to store a process that is executable by the processor, the process, when executed, configured to: detect usage of an external application programming interface in execution of an application; transmit a query to the external application programming interface for a list of one or more components of the external application programming interface; generate a vulnerability assessment for the application based on a response to the query; and perform one or more mitigation actions based on the vulnerability assessment.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
detecting, by a process, usage of an external application programming interface in execution of an application;
transmitting, by the process, a query to the external application programming interface for a list of one or more components of the external application programming interface;
generating, by the process, a vulnerability assessment for the application based on a response to the query; and
performing, by the process, one or more mitigation actions based on the vulnerability assessment.

2. The method as in claim 1, wherein detecting usage of the external application programming interface in execution of the application comprises:
monitoring activity of the application; and
determining a new call made to the external application programming interface during execution of app,
wherein the query is transmitted in response to the new call to the external application programming interface.

3. The method as in claim 1, wherein detecting usage of the external application programming interface in execution of the application is performed during development of the application, during deployment of the application, and/or during runtime of the application.

4. The method as in claim 1, further comprising:
learning of a new vulnerability associated with a specific component;
determining whether the application has any external application programming interfaces that have that specific component; and
updating the vulnerability assessment based on whether the application has any external application programming interfaces that have that specific component.

5. The method as in claim 4, further comprising:
determining whether it is known that a given external application programming interface of the application has that specific component; and
in response to determining that is unknown whether the given external application programming interface of the application has that specific component, querying the given external application programming interface of the application for presence of the specific component.

6. The method as in claim 1, wherein the query for the list of one or more components and the response to the query are based on a software bill of materials for the external application programming interface.

7. The method as in claim 1, wherein the query to the external application programming interface for the list of one or more components of the external application programming interface comprises a query for a full list of all components of the external application programming interface.

8. The method as in claim 1, wherein the query to the external application programming interface for the list of one or more components of the external application programming interface comprises a query for presence of one or more specifically queried components of the external application programming interface.

9. The method as in claim 1, wherein the application is selected from a group consisting of: an application; an application micro service; a workload; a containerized workload; an image; a container; a local application; and a virtual application.

10. The method as in claim 1, wherein the vulnerability assessment corresponds to one or more of the external application programming interface in its entirety, one or more individual components of the external application programming interface, or a plurality of external application programming interfaces of the application.

11. The method as in claim 1, wherein the vulnerability assessment is based on one or both of Common Vulnerability Scoring System scores and bug reports and fixes for specified components.

12. The method as in claim 1, wherein the process is part of a cloud-native application protection platform.

13. The method as in claim 1, wherein performing the one or more mitigation actions based on the vulnerability assessment comprises:
triggering a customized policy action based on the vulnerability assessment.

14. The method as in claim 1, wherein the one or more mitigation actions are selected from a group consisting of: sending an alert regarding the external application programming interface; sending a report regarding the external application programming interface; blocking certain components of the external application programming interface; blocking the external application programming interface; blocking the application; and redirecting calls to the external application programming interface.

15. A tangible, non-transitory, computer-readable medium having computer-executable instructions stored thereon that, when executed by a processor on a computer, cause the computer to perform a method comprising:
detecting usage of an external application programming interface in execution of an application;
transmitting a query to the external application programming interface for a list of one or more components of the external application programming interface;
generating a vulnerability assessment for the application based on a response to the query; and
performing one or more mitigation actions based on the vulnerability assessment.

16. The tangible, non-transitory, computer-readable medium as in claim 15, wherein detecting usage of the external application programming interface in execution of the application comprises:
monitoring activity of the application; and
determining a new call made to the external application programming interface during execution of app,
wherein the query is transmitted in response to the new call to the external application programming interface.

17. The tangible, non-transitory, computer-readable medium as in claim 15, wherein the method further comprises:
learning of a new vulnerability associated with a specific component;
determining whether the application has any external application programming interfaces that have that specific component; and
updating the vulnerability assessment based on whether the application has any external application programming interfaces that have that specific component.

18. The tangible, non-transitory, computer-readable medium as in claim 15, wherein the query for the list of one or more components and the response to the query are based on a software bill of materials for the external application programming interface.

19. The tangible, non-transitory, computer-readable medium as in claim 15, wherein the query to the external application programming interface for the list of one or more components of the external application programming interface comprises one of either a query for a full list of all components of the external application programming interface or a query for presence of one or more specifically queried components of the external application programming interface.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
detect usage of an external application programming interface in execution of an application;
transmit a query to the external application programming interface for a list of one or more components of the external application programming interface;
generate a vulnerability assessment for the application based on a response to the query; and
perform one or more mitigation actions based on the vulnerability assessment.
